(19) United States
(12) Patent Application Publication
(10) Pub. No.: US 2016/0292780 A1
(43) Pub. Date: Oct. 6, 2016

(54) INTERACTIVE COMMUNICATION METHOD AND APPARATUS

(71) Applicant: Alibaba Group Holding Limited, Grand Cayman (KY)

(72) Inventor: Shengzhi Ren, Hangzhou (CN)

(21) Appl. No.: 15/080,211

(22) Filed: Mar. 24, 2016

(30) Foreign Application Priority Data
Apr. 3, 2015 (CN) 201510158446.1

(51) Int. Cl. G06Q 30/06; G06K 9/46; G06T 11/60; H04L 29/06; G06K 9/62

(52) U.S. Cl. CPC G06Q 30/0643; H04L 63/08; G06K 9/6201; G06T 11/60; G06K 9/46

(57) ABSTRACT

An interactive communication method and an apparatus thereof are disclosed. The method includes obtaining a degree of matching between a product image and a user image, and establishing a connection with a product image provider in response to the degree of matching being greater than a preset threshold. The disclosed interactive communication method and apparatus perform a matching between a product image and a user image, and obtain a degree of matching between the product image and the user image. When the degree of matching between the product image and the user image meets a preset criterion, a connection between a user and a product provider is established. Thus, a better effect of product experience is achieved for an online shopper to select and purchase a product. Furthermore, an interactive communication between the product provider and the online shopper is enhanced.

### CROSS REFERENCE TO RELATED PATENT APPLICATION

This application claims foreign priority to Chinese Patent Application No. 201510158446.1 filed on Apr. 3, 2015, entitled “Interactive Communication Method and Apparatus”, which is hereby incorporated by reference in its entirety.

### TECHNICAL FIELD

The present disclosure relates to the field of communication technologies, and in particular, to interactive communication methods and apparatuses.

### BACKGROUND

With the rapid development of the Internet industry, online shopping on the Internet has become increasingly popular in people's lives. However, a major difference between online shopping and street shopping is that it is impossible to view physical products and touch physical materials of the physical products, and it is especially impossible to try on/wear fashion-related products prior to a purchase decision, which greatly reduces a rate of closing a transaction associated with online shopping. Getting a better shopping experience during online shopping and establishing a more comprehensive communication pattern with merchandise providers have gradually become two of the most important demands of purchasers of merchandise.

To solve the aforementioned problems, an image of a model dressed-in/wearing a product is generally placed in product information for users to browse online. However, owing to differences between the users and the model in aspects such as body shape, skin color, etc., great differences may exist in dressing-in/wearing effects of fashion products if purchases are made based on pictures illustrating effects in which the model is dressed-in/wearing associated clothes. As people pursue fashion and shopping convenience and the like, this problem urgently needs to be solved in online shopping.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the above, an interactive communication method and an apparatus thereof need to be provided to solve the aforementioned problem that a user is not able to try on/wear a product during online shopping.

In view of the above, the present disclosure provides an interactive communication method, which includes obtaining a degree of matching between a product image and a user image; and establishing a connection with a product image provider if the degree of matching is greater than a preset threshold.

In implementations, obtaining the degree of matching between the product image and the user image may include matching and overlaying the product image on the user image; displaying a matched image; and obtaining a degree of matching inputted by a user based on the matched image that is displayed.

In implementations, matching and overlaying of the product image on the user image may include extracting information of the user image; and matching the user image with the product image in terms of size and/or position.

In implementations, the interactive communication method may further include fine-tuning the matched image according to an operation of fine-tuning the matched image performed by the user.

In implementations, the interactive communication method may further include replacing the product image in the matched image according to an operation of replacing the product image in the matched image performed by the user.

In implementations, obtaining the degree of matching between the product image and the user image may include calculating the degree of matching based on features of the product image and the user image, the features including one or more of a size, a shape or a color.

In implementations, the connection may include one or more of a connection for voice communication, a connection for video communication or a connection for text communication.

In implementations, establishing a connection for voice communication with the product image provider may include determining identity authentication of the user and connection conditions of audio components according to a request for the voice communication; and establishing the voice communication upon successful determination.

In implementations, establishing a connection for video communication with the product image provider may include determining identity authentication of the user and connection conditions of video components according to a request for the video communication; and establishing the video communication upon successful determination.

In implementations, establishing a connection for text communication with the product image provider may include determining identity authentication of the user according to a request for the video communication; and establishing the text communication upon successful determination.

In implementations, after establishing the connection with the product image provider, the method may further include displaying the matched image to the product image provider.

In implementations, the user image is collected via an image capturing component or retrieved from a storage device.

In implementations, the product image is extracted from product information.

The present disclosure further provides an apparatus for interactive communication, which may include a first apparatus used for obtaining a degree of matching between a product image and a user image; and a second apparatus used for establishing a connection with a product image provider when the degree of matching is greater than a preset threshold.

In implementations, the first apparatus may include a first-first module used for matching and overlaying the product image on the user image; a first-second module used for displaying a matched image; and a first-third module used for obtaining a degree of matching inputted by a user based on the matched image that is displayed.

In implementations, the first-first module may include a first-first-first unit used for extracting information of the user image; and a first-first-second unit used for matching the user image with the product image in terms of size and/or position.

In implementations, the apparatus may further include a third apparatus used for fine-tuning the matched image according to an operation of fine-tuning the matched image performed by the user.

In implementations, the apparatus may further include a fourth apparatus used for replacing the product image in the matched image according to an operation of replacing the product image in the matched image performed by the user.

In implementations, the first apparatus may further include a first-fourth module used for calculating the degree of matching based on features of the product image and the user image, the features including one or more of size, shape or color.

In implementations, the second apparatus may include one or more of a second-first module, a second-second module or a second-third module. The second-first module is used for establishing a connection for voice communication with the product image provider. The second-second module is used for establishing a connection for video communication with the product image provider. The second-third module is used for establishing a connection for text communication with the product image provider.

In implementations, the second-first module may include a second-first-first unit used for detecting identity authentication of the user and connection conditions of audio components according to a request for voice communication; and a second-first-second unit used for establishing the voice communication upon successful determination.

In implementations, the second-second module may include a second-second-first unit used for detecting identity authentication of the user and connection conditions of video components according to a request for video communication; and a second-second-second unit used for establishing the video communication upon successful determination.

In implementations, the second-third module may include a second-third-first unit used for detecting identity authentication of the user according to a request for text communication; and a second-third-second unit used for establishing the text communication upon successful determination.

In implementations, the apparatus may further include a third apparatus used for displaying the matched image to the product image provider.

In implementations, the first apparatus may include a first-fifth module used for collecting the user image via an image capturing component or retrieving the user image from a storage device.

In implementations, the first apparatus may include a first-sixth module used for extracting the product image from product information.

As compared with existing technologies, the disclosed interactive communication method and apparatus perform a matching between a product image and a user image, and obtain a degree of matching between the product image and the user image. When the degree of matching between the product image and the user image meets a preset criterion, a connection between a user and a product provider is established. Specifically, the user is able to determine whether to make a request for establishing a connection with the product provider for further communication after observing an effect of the matching between the product image and the user image. The present disclosure achieves a better effect of product experience for an online shopper to select and purchase a product. Furthermore, an interactive communication between the product provider and the online shopper is enhanced.

### BRIEF DESCRIPTION OF THE DRAWINGS

FIG. 1 is a schematic diagram of an interactive communication apparatus in accordance with an embodiment of the present disclosure.

FIG. 2 is a schematic diagram of an interactive communication apparatus in accordance with another embodiment of the present disclosure.

FIG. 3 is a schematic diagram of an interactive communication apparatus in accordance with another embodiment of the present disclosure.

FIG. 4 is a schematic diagram of an interactive communication apparatus in accordance with another embodiment of the present disclosure.

FIG. 5 is a schematic diagram of an interactive communication apparatus in accordance with another embodiment of the present disclosure.

FIG. 6 is a schematic diagram of an interactive communication apparatus in accordance with another embodiment of the present disclosure.

FIG. 7 is a schematic diagram of an interactive communication apparatus in accordance with another embodiment of the present disclosure.

FIG. 8 is a flowchart of an interactive communication method in accordance with an embodiment of the present disclosure.

FIG. 9 is a flowchart of obtaining a degree of matching between a product image and a user image in an interactive communication method in accordance with an embodiment of the present disclosure.

FIG. 10 is a flowchart of matching and overlaying a product image on a user image in an interactive communication method in accordance with an embodiment of the present disclosure.

FIG. 11A is a flowchart of establishing a communication connection in an interactive communication method in accordance with an embodiment of the present disclosure.

FIG. 11B is a flowchart of establishing a communication connection in an interactive communication method in accordance with another embodiment of the present disclosure.

FIG. 11C is a flowchart of establishing a communication connection in an interactive communication method in accordance with another embodiment of the present disclosure.

The same or similar labels in the accompanying drawings represent the same or similar components.

### DETAILED DESCRIPTION

In a typical configuration of the present disclosure, a terminal, a service network device and a trusted party each include one or more central processing units (CPUs), an input/output interface, a network interface and memory.

The memory may include a form of computer-readable media, e.g., a non-permanent storage device, random-access memory (RAM) and/or a nonvolatile internal storage, such as read-only memory (ROM) or flash RAM. The memory is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

To further illustrate technical solutions employed and effects achieved in the present disclosure, the technical solutions of the present disclosure are clearly and completely described herein in conjunction with the drawings and exemplary embodiments.

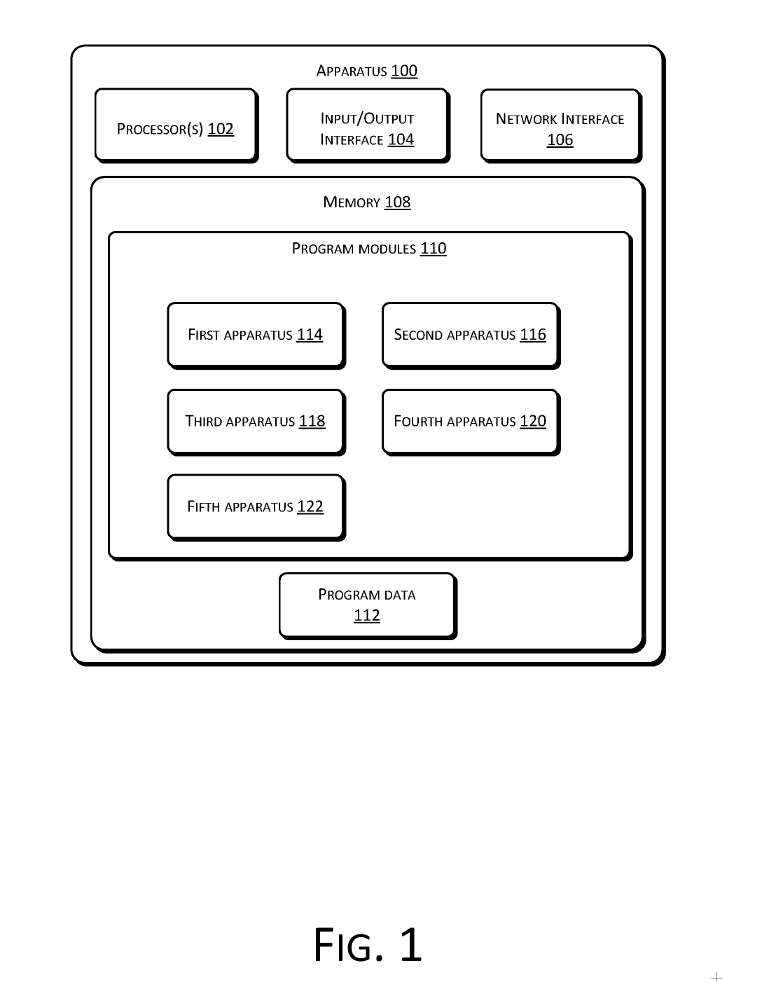

FIG. 1 shows a schematic diagram of an interactive communication apparatus 100 according to the present disclosure. In implementations, the interactive communication apparatus 100 may include one or more processors 102, an input/output interface 104, a network interface 106 and memory 108. In implementations, the memory 108 may include a form of computer-readable media, e.g., a non-permanent storage device, random-access memory (RAM) and/or a nonvolatile internal storage, such as read-only memory (ROM) or flash RAM. The memory 108 is an example of computer-readable media as described in the foregoing description. The memory 108 may include program modules 110 and program data 112.

In implementations, the interactive communication apparatus 100 or the memory 108 may include a first apparatus 114 used for obtaining a degree of matching between a product image and a user image; and a second apparatus 116 used for establishing a connection with a product image provider when the degree of matching is greater than a preset threshold.

In the present embodiment, a matching is performed for the product image and the user image. The first apparatus 114 obtains a degree of matching after these two images are matched according to a preset matching degree rule, and no limitation is imposed on the matching degree rule. For example, the degree of matching may be a degree of matching between the product image and the user image in terms of size, color, style, etc. In implementations, the degree of matching may be set up in advance in a client terminal of a user, and the client terminal may directly compare the degree of matching with a preset matching degree parameter according to specific condition(s) of the matched image, to further calculate a value of the degree of matching. Alternatively, the degree of matching may be a satisfaction degree of an overall effect of the matched image that is formed in the user's mind after the user views the matched image and the user inputs the degree of matching via the client terminal. A criterion that needs to be met for the second apparatus 116 to establish a connection between the user and the product provider may be determined by the satisfaction degree after the user observes an effect of the matched image. When the user is satisfied with the effect after the product image and the user image are matched, the user may further request for establishing a connection with the product provider for further communication. Alternatively, the criterion may include: the user client terminal comparing the degree of matching with a preset matching degree threshold after obtaining the degree of matching between the product image and the user image, and generating an inquiry message and showing the inquiry message on a display interface of the client terminal to ask the user whether to allow a connection to be established with the product provider if the degree of matching is greater than the preset degree of matching threshold. For example, a message window similar to “The product is nice. Would you like to contact the seller?” may pop up on the display interface of the client terminal. The present embodiment is able to achieve a better effect of product experience for an online shopper when shopping for a product. Furthermore, an interactive communication between the product provider and the online shopper is enhanced.

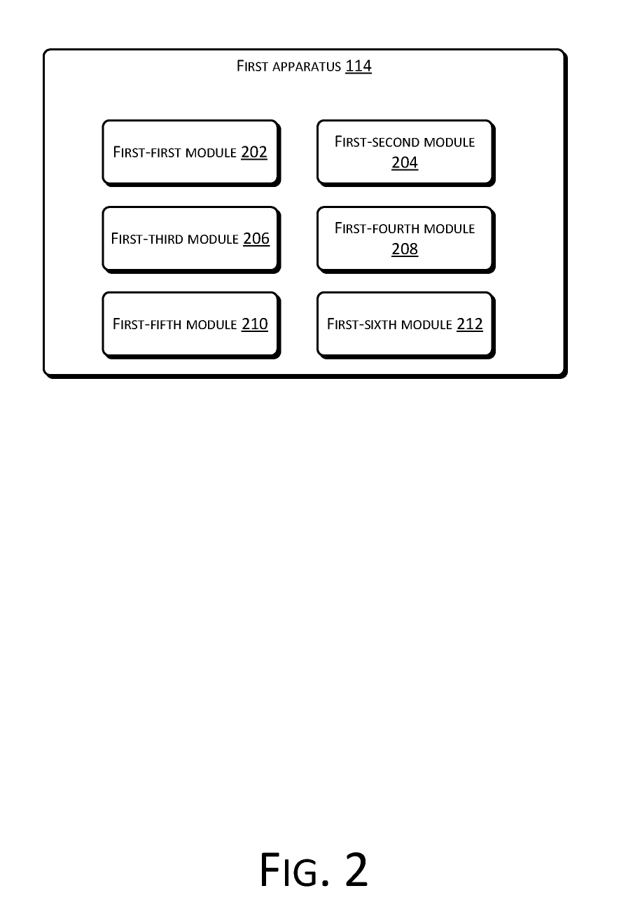

As shown in FIG. 2, in an embodiment, the first apparatus 114 in the interactive communication apparatus 100 may include a first-first module 202 used for matching and overlaying the product image on the user image; a first-second module 204 used for displaying a matched image; and a first-third module 206 used for obtaining a degree of matching inputted by a user based on the matched image that is displayed.

In the present embodiment, a display component of a client terminal of the apparatus 100 may display information, such as image(s), text(s), etc., of a product to the user. When the user browses the information of the product, feels fairly satisfied with the browsed product and desires to further determine whether the product is suitable, the user may request to match the product image with his/her image, observe a matching effect and determine whether to buy the product. After seeing the matched image, the user may also input a degree of matching between the product image and the user image in the client terminal based on a degree of satisfaction of the matching effect. In practice, a way of requesting to match the product image with the user image may include the user clicking on a “Try” button in the display interface. Alternatively, the matching of the product image with the user image may be triggered in response to collecting information such as a text, a voice, a gesture, or a posture, etc., that represents a desire of the user to see a matched image. For example, after a microphone of the client terminal collects audio information of “I want to have a try” from the user, an interface in which the product image and the user image are matched is entered. After observing an effect of the matched image, the user may determine whether to establish a connection with a product seller. If a connection with the seller is needed to be established, the user may input a request indicating his/her desires to communicate with the seller to the client terminal. At this time, the degree of matching is greater than a preset threshold, the connection between the user and the seller is established through the second apparatus 116. However, the threshold herein is preset in the user's mind, and whether to contact with the seller is decided by the user.

In addition, in the present embodiment, a communication connection between a user and a product provider may not be established through the second apparatus 116 each time after a product image is matched with a user image. After observing the effect of the matched image, the user may determine whether he/she needs to communicate with the product provider. In general, when the user feels unsatisfied after seeing the matched image, the user may not communicate with the product provider. Apparently, a situation may exist that the user feels very satisfied after seeing the matched image, thinks it is unnecessary to communicate with the product provider, and desires to buy the product directly.

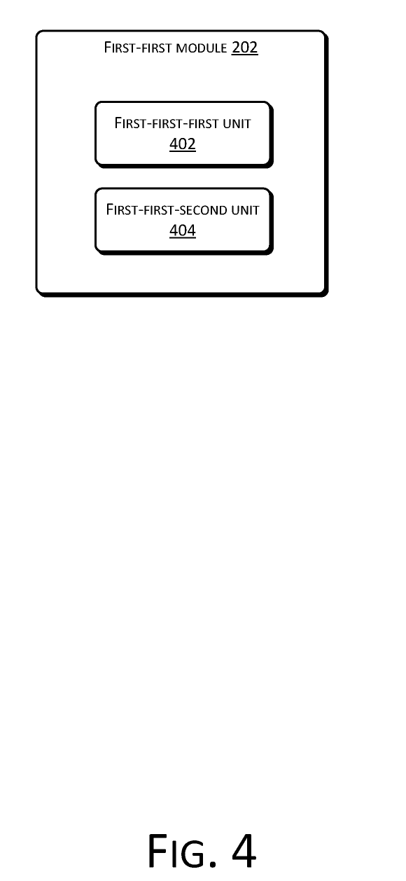

As shown in FIG. 4, in an embodiment, the first-first module 202 in the interactive communication apparatus 100 may include a first-first-first unit 402 used for extracting information of the user image; and a first-first-second unit 404 used for matching the user image with the product image in terms of size and/or position.

In the present embodiment, when the first-first module 202 matches the product image with the user image, particular parameter(s) of the user image is/are extracted via the first-first-first unit 402. The particular parameter(s) may include a contour, a shape, a predefined unique image feature, a size, a color, a facial position, etc. A fuzzy matching in size between the user image and the product image may then be performed through the first-first-second unit 404. The fuzzy matching in size is referred to as a fuzzy matching performed based on product attributes and sizes of the product and the user image. For example, if the product is a dress, when the product image and the user image are matched, the size of the image of the dress overlaid on the user image needs to be about 80% of that of the user image. If the product is a pair of trousers, when the product image and the user image are matched, the size of the image of the trousers overlaid on the user image needs to be about 50% of that of the user image. Matching the user image with the product image in terms of position may also be performed through the first-first-second unit 404. The position matching is referred to as a matching performed based on product attributes and a rough position of the user image on which the product image to be overlaid. For example, if the product is a T-shirt, the image of the T-shirt needs to be overlaid on the upper part of the user image when the product image and the user image are matched. If the product is a watch, the image of the watch needs to be overlaid on a side position in the middle of the user image when the product image and the user image are matched. In addition, in the present embodiment, the matching between the user image and the product image may be matching with respect to both size and position, or matching with respect to one of the size and the position. Apparently, the matching effect is the best when matching is performed with respect to both the size and the position.

As shown in FIG. 1, in an embodiment, the interactive communication apparatus 100 may further include a third apparatus 118 used for fine-tuning the matched image according to an operation of fine-tuning the matched image performed by the user.

In the present embodiment, after observing an effect of the matched image, the user may perform fine-tuning to achieve the best shopping experience according to particular needs. For example, during matching, a dislocation may be inevitable in a matched image as the matching is performed only with respect to either size or position. At this time, the matched image may be finely tuned by the user through a related operation. Apparently, even if the matching is performed with respect to both size and position, it fine-tuning of the matched image may also be performed. No limitation is imposed on the details of a fine-tuning method. For TV shopping, fine-tuning may be performed simply via buttons on a remote control, for example. For shopping via a touchscreen mobile phone, fine-tuning may be performed by touching screen buttons, etc., for example.

As shown in FIG. 1, in an embodiment, the interactive communication apparatus 100 may further include a fourth apparatus 120 used for replacing the product image in the matched image based on an operation of replacing the product image in the matched image performed by the user.

In the present embodiment, after observing the effect of the matched image, the user may change model and color of products of the same type to achieve the best shopping experience. By changing different sizes and colors of the same product only, the position of the user image which the product image is matched with and overlaid on is not changed after the change. For example, the user selects a dress. After observing an effect of matching and overlaying a dress image on his/her image, the user finds that a color of the dress does not suit his/her skin color very well. At that time, he/she may replace the dress image with another image of a dress in a different color through a related operation to achieve the best shopping experience. A precondition of such replacement is that product images used for matching the user image exist in the product information. No limitation is imposed on the details of a manner of replacing a product. For TV Shopping, a replacement of a product may be performed via simple buttons on a remote control, for example. For shopping via a touchscreen mobile phone, a replacement of a product may be performed by touching screen buttons, etc., for instance.

As shown in FIG. 2, in an embodiment, the first apparatus 114 in the interactive communication apparatus 100 may further include a first-fourth module 208 used for calculating the degree of matching based on features of the product image and the user image, the features including one or more of size, shape or color.

In the present embodiment, a degree of matching may be a level of matching between the product image and the user image with respect to a size, a color, a style, etc. A method of calculating the degree of matching may be set up in the user client terminal in advance. The client terminal may further calculate a value of the degree of matching directly based on specific condition(s) of the matched image using a preset method of calculating the degree of matching. For example, a size and a color may be taken as matching degree parameters. When a level of matching between a product image and a user image with respect to size is within a difference range of 1 cm, a degree of matching between these two images with respect to size is 90%. When the level of matching between the product image and the user image with respect to size is within a difference range of 1-2 cm, the degree of matching between these two images with respect to size is 80%. Similarly, a corresponding degree of matching may also be set up based on a level of matching between two images with respect to color. After the matching between the product image and the user image is finished, the client terminal may calculate a degree of matching every time based on specific condition(s) for matching the two images and a corresponding preset method of calculating a degree of matching. When the user observes the effect of the matched image and cannot determine a degree of satisfaction thereof, to the user may input a reasonable value for the degree of matching through the client terminal. Based on a comparison result between an obtained value for the degree of matching and a preset threshold, the client terminal may also prompt the user that “The product is very suitable. Would you like to contact the seller?”, to improve a success rate of product transaction. In particular, users who are lack of confidence in buying clothes may buy products suitable for themselves in this way.

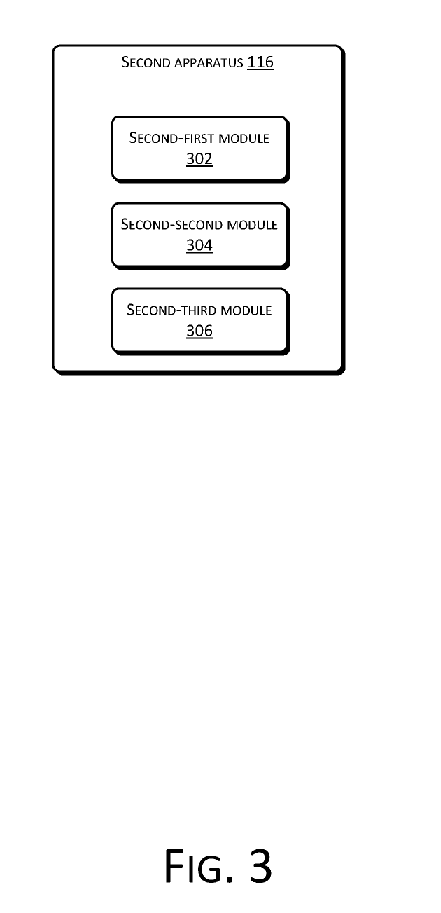

As shown in FIG. 3, the second apparatus 116 in the interactive communication apparatus 100 may include one or more of a second-first module 302, a second-second module 304 or a second-third module 306. The second-first module 302 is used for establishing a connection for voice communication with the product image provider. The second-second module 304 is used for establishing a connection for video communication with the product image provider. The second-third module 306 is used for establishing a connection for text communication with the product image provider.

In the present embodiment, the interactive communication apparatus 100 establishes a communication between the user and the product provider through the second apparatus 116, which may also be triggered by the user as needed. In implementations, the second apparatus 116 may be triggered to establish a connection for voice communication between a user and a seller in response to the user clicking on a “Call the seller” button displayed in an interface, or by collecting information such as a text, a voice, a gesture, a posture, etc., that is indicative of the user's desire to communicate with the seller. For example, when an image capturing component of the client terminal collects a mouth shape or a corresponding gesture, etc., of the user that sounds like “Make a video communication with the seller”, the second-second module 304 in the second apparatus 116 may be triggered to establish a connection for video communication between the user and the seller.

In addition, in the present embodiment, situations in which a user and a seller conduct a communication through texts, voice and video at the same time may exist. Alternatively, only one or more than one thereof may exist. In general, during TV shopping, a user communicates with a seller mainly through voice or video because inputting a text into a device is not so convenient. No limitation is imposed on the details of a communication method, and a method of communicating with a seller may be selected by a user according to a client terminal used by the user and an environment where the user is located. For example, in an environment such as a public place or a library, a user may prefer to communicate with a seller through a text communication. While at home or in a rather private environment, the user may prefer to communicate with the seller through a voice communication or a video communication, for example.

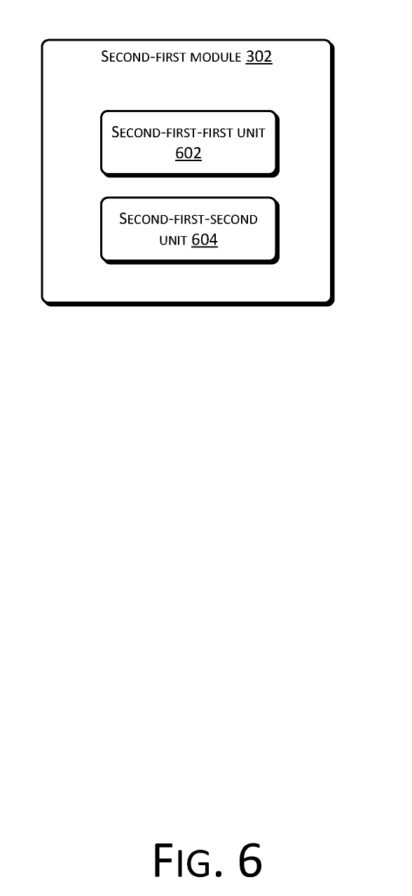

As shown in FIG. 6, in an embodiment, the second-first module 302 in the interactive communication apparatus 100 may include a second-first-first unit 602 used for determining an identity authentication of the user and connection condition(s) of audio component(s) according to a request for voice communication, and a second-first-second unit 604 used for establishing a connection for the voice communication upon successful determination.

In the present embodiment, during a process of establishing a voice communication between the user and the product seller, the second-first-first unit 602 needs to authenticate an identity of the user. Under general circumstances, the user is needed to be a member of an associated online shopping platform. In other words, the user has registration information and a login of the user is completed. For example, when shopping in a Taobao/TMALL shopping platform, a Taobao account or an associated account of another platform recognized by the shopping platform needs to be logged in. The second-first-first unit 602 also needs to determine whether a hardware environment for a voice communication is permitted, for example, whether audio receiving/playing device(s) such as a microphone, a loudspeaker, etc., is/are connected. Upon completing the above determination, the second-first-second unit 604 may establish a connection for voice communication between the user and the seller. No limitation is imposed on the details of implementations of establishing a voice communication, and implementations may be achieved in combination with instant messaging software, for example, Ali Wangwang®, Tencent QQ®, etc.

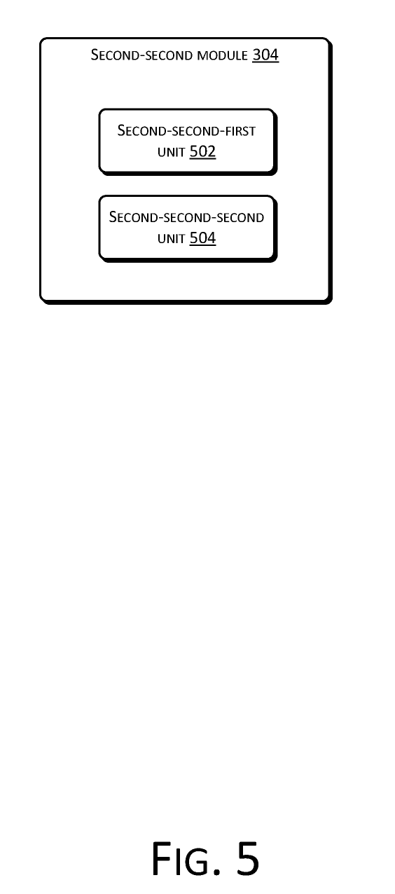

As shown in FIG. 5, in an embodiment, the second-second module 304 in the interactive communication apparatus 100 may include a second-second-first unit 502 used for determining an identity authentication of the user and connection condition(s) of video component(s) according to a request for video communication; and a second-second-second unit 504 used for establishing a connection for the video communication upon successful determination.

In the present embodiment, during a process of establishing a voice communication between the user and the product seller, the second-second-first unit 502 needs to authenticate an identity of the user. Under general circumstances, the user needs to be a member of an associated online shopping platform. In other words, the user has registration information and a login of the user is finished. For example, when shopping in a Taobao/TMALL shopping platform, a Taobao account or an associated account of another platform recognized by the shopping platform needs to be logged in. The second-second-first unit 502 also needs to determine whether a hardware environment for the video communication is permitted, for example, whether video receiving/playing device(s) such as a camera, a microphone, a loudspeaker, etc., is/are connected. Upon completing the above determination, the second-second-second unit 504 may establish a connection for the video communication between the user and the seller. No limitation is imposed on the details of implementations of establishing a video communication, and implementations may be achieved in combination with instant messaging software, for example, Ali Wangwang®, Tencent QQ®, Fetion®, etc.

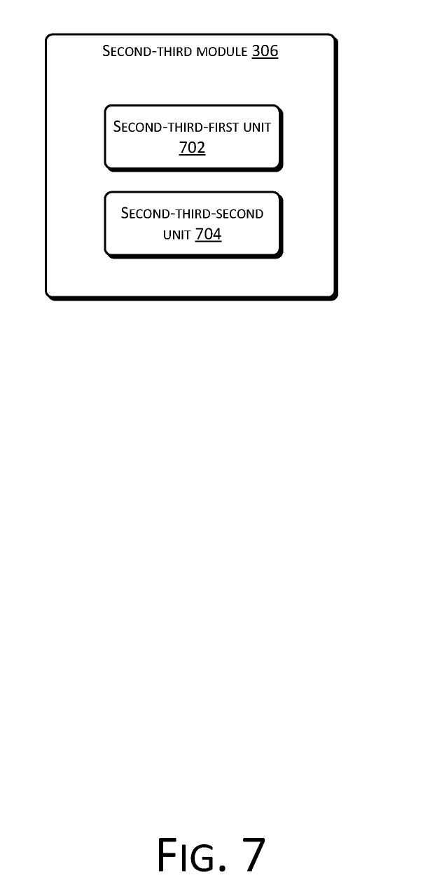

As shown in FIG. 7, in an embodiment, the second-third module 306 in the interactive communication apparatus 100 may include a second-third-first unit 702 used for determining an identity authentication of the user according to a request for text communication; and a second-third-second unit 704 used for establishing a connection for the text communication upon successful determination.

In the present embodiment, during a process of establishing a text communication between the user and the product seller, the second-third-first unit 702 needs to authenticate an identity of the user. Under general circumstances, the user needs to be a member of an associated online shopping platform. In other words, the user has registration information and a login of the user is finished. For example, when shopping in a Taobao/TMALL shopping platform, a Taobao account or an associated account of another platform recognized by the shopping platform needs to be logged in. The second-third-first unit 702 may also determine whether a hardware environment for a text communication is permitted, for example, whether text input device(s), such as a voice-to-text conversion device, a keyboard, button(s), is/are connected well. Upon completing the above determination, the second-third-second unit 704 may establish a connection for the text communication between the user and the seller. No limitation is imposed on the details of implementations of establishing a text communication, and implementations may be achieved in combination with instant messaging software, for example, Ali Wangwang®, Wechat®, Fetion®, etc.

As shown in FIG. 1, in an embodiment, the interactive communication apparatus 100 may further include a fifth apparatus 122 used for displaying the matched image to the product image provider.

In the present embodiment, after the second apparatus 116 establishes the communication connection, the user may choose to permit the matched image to be displayed on a terminal of the product seller, or choose not to permit the matched image to be displayed on the terminal of the product seller. Furthermore, during a process of communication with the user, the product seller may also submit a request for viewing the matched image. After the request is approved by the user, the matched image may also be displayed on the client terminal of the seller. The fifth apparatus 122 achieves a transmission of the matched image to the client terminal of the seller via the established communication connection, to allow a display of the matched image on the client terminal of the seller. Transmission thereof may also be performed through the Internet if both the client terminal of the user and the client terminal of the seller are connected to the Internet, for example. No limitation is imposed on the details of a transmission method.

As shown in FIG. 2, in an embodiment, the first apparatus 114 in the interactive communication apparatus 100 may include a first-fifth module 210 used for collecting the user image through an image capturing component or retrieving the user image from a storage device.

In the present embodiment, the first-fifth module 210 is set up for providing the user image for the matching between the user image and the product image. The image capturing component is connected with the client terminal of the user, or directly integrated and deployed in the client terminal of the user, which may be a camera, an image scanner and other devices for collecting image information. In this case, the user image may be obtained and collected through a relevant device. In addition, the user image may also be obtained by directly retrieving an image pre-stored in a storage device. For example, image information stored in the client terminal of the user may be directly selected, and a more suitable image is selected for matching with the product image based on preference(s) of the user and one or more criteria for the matching of the product to be bought. For another example, the user may wish to buy a scarf to match his/her coat. Under a circumstance that the user does not wear the coat or no camera device is present, the user may directly obtain an image thereof when wearing the aforementioned coat from the storage device of the client terminal for matching with the scarf image, and further observe a matching effect, in order to maximize online shopping experience and buy the most suitable product.

In addition, since the user image may be obtained from the storage device, the user may retrieve any image in the client terminal at will to match with the product image, thus enabling the user to buy suitable products for his/her relatives, friends and classmates, and thereby making online shopping to meet people's demands more closely and to be more humanized.

As shown in FIG. 2, in an embodiment, the first apparatus 114 in the interactive communication apparatus 100 may include a first-sixth module 212 used for extracting the product image from product information.

In the present embodiment, the first-sixth module 212 is mainly employed in a scenario that the product image does not exist alone in the product information. For example, the product image may be placed together with a beautiful packing box of the product or the product is put on/worn by a product model in the product information browsed by the user during online shopping. In this case, prior to matching the user image with the product image, the first-sixth module 212 needs to extract the product image to allow the product image to match with the user image. An example implementation of extracting an image of a product by the first-sixth module 212 may include collecting an image and making portion(s) of the image that do(es) correspond to the product transparent or covering the portion(s) in a colorless manner, etc.

As compared with existing technologies, the disclosed interactive communication method and apparatus perform a matching between a product image and a user image, and obtain a degree of matching between the product image and the user image. When the degree of matching between the product image and the user image meets a preset criterion, a connection between a user and a product provider is established. Specifically, the user is able to determine whether to make a request for establishing a connection with the product provider for further communication after observing an effect of the matching between the product image and the user image. The present disclosure achieves a better effect of product experience for an online shopper to select and purchase a product. Furthermore, an interactive communication between the product provider and the online shopper is enhanced. In particular, after viewing the matched image, the user may perform fine-tuning on the matched image to enhance the matching effect. The user may also select a more suitable product by changing a size and/or a color within a range of products of the same type. In addition, when the user needs to establish a connection with the seller, a communication connection mode such as voice, text and video may be selected, which makes the online shopping of the user to be more humanized.

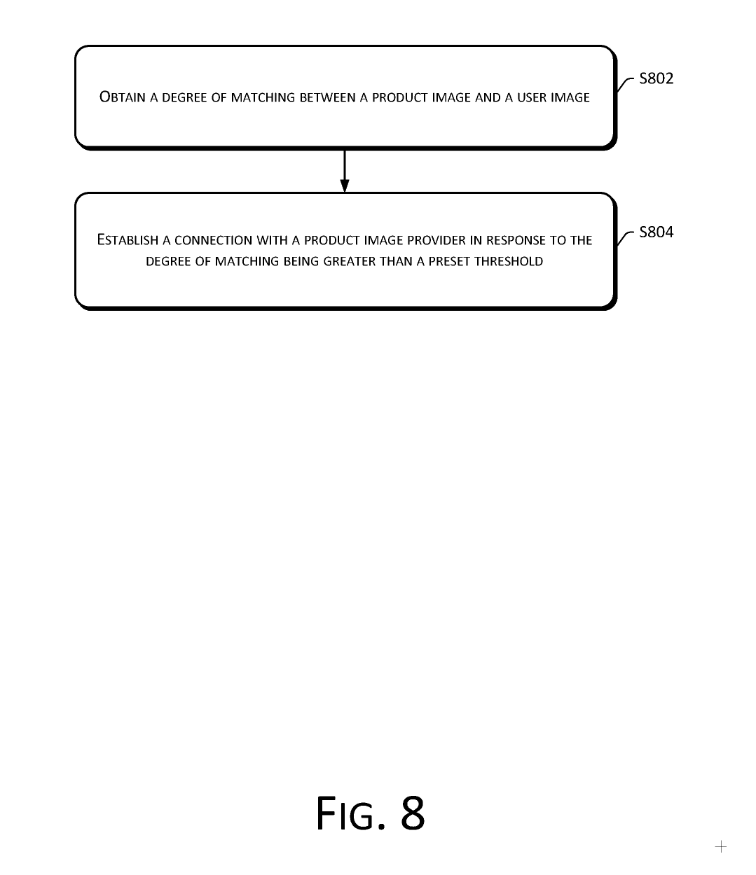

FIG. 8 shows a flowchart of an interactive communication method 800 according to the present disclosure. In implementations, the method 800 may include the following method blocks.

S802 obtains a degree of matching between a product image and a user image.

S804 establishes a connection with a product image provider in response to the degree of matching being greater than a preset threshold.

In the present embodiment, a matching is performed for the product image and the user image. A degree of matching is obtained after these two images are matched according to a preset matching degree rule, and no limitation is imposed on the matching degree rule. For example, the degree of matching may be a degree of matching between the product image and the user image in terms of size, color, style, etc. In implementations, the degree of matching may be set up in advance in a client terminal of a user, and the client terminal may directly compare the degree of matching with a preset matching degree parameter according to specific condition(s) of the matched image, to further calculate a value of the degree of matching. Alternatively, the degree of matching may be a satisfaction degree of an overall effect of the matched image that is formed in the user's mind after the user views the matched image and the user inputs the degree of matching via the client terminal. A criterion that needs to be met for establishing a connection between the user and the product provider may be determined by the satisfaction degree after the user observes an effect of the matched image. When the user is satisfied with the effect after the product image and the user image are matched, the user may further request for establishing a connection with the product provider for further communication. Alternatively, the criterion may include: the user client terminal comparing the degree of matching with a preset matching degree threshold after obtaining the degree of matching between the product image and the user image, and generating an inquiry message and showing the inquiry message on a display interface of the client terminal to ask the user whether to allow a connection to be established with the product provider if the degree of matching is greater than the preset degree of matching threshold. For example, a message window similar to “The product is nice. Would you like to contact the seller?” may pop up on the display interface of the client terminal. The present embodiment is able to achieve a better effect of product experience for an online shopper when shopping for a product. Furthermore, an interactive communication between the product provider and the online shopper is enhanced.

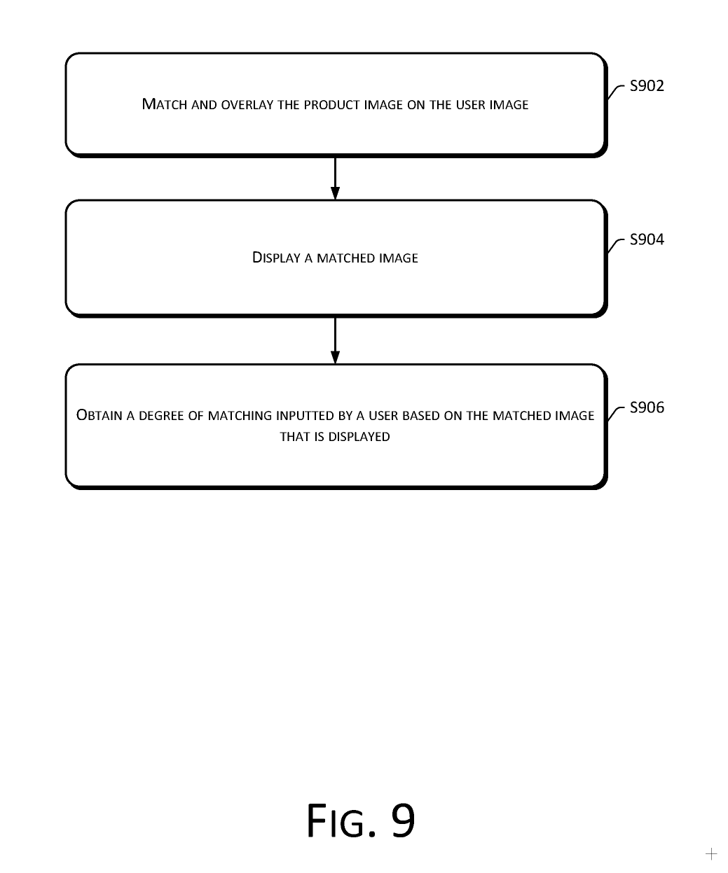

As shown in FIG. 9, in an embodiment, obtaining the degree of matching between the product image and the user image may include the following method blocks.

S902 matches and overlays the product image on the user image.

S904 displays a matched image.

S906 obtains a degree of matching inputted by a user based on the matched image that is displayed.

In the present embodiment, a display component of a client terminal may display information, such as image(s), text(s), etc., of a product to the user. When the user browses the information of the product, feels fairly satisfied with the browsed product and desires to further determine whether the product is suitable, the user may request to match the product image with his/her image, observe a matching effect and determine whether to buy the product. After seeing the matched image, the user may also input a degree of matching between the product image and the user image in the client terminal based on a degree of satisfaction of the matching effect. In practice, a way of requesting to match the product image with the user image may include the user clicking on a “Try” button in the display interface. Alternatively, the matching of the product image with the user image may be triggered in response to collecting information such as a text, a voice, a gesture, or a posture, etc., that represents a desire of the user to see a matched image. For example, after a microphone of the client terminal collects audio information of “I want to have a try” from the user, an interface in which the product image and the user image are matched is entered. After observing an effect of the matched image, the user may determine whether to establish a connection with a product seller. If a connection with the seller is needed to be established, the user may input a request indicating his/her desires to communicate with the seller to the client terminal. At this time, the degree of matching is greater than a preset threshold, the connection between the user and the seller is established. However, the threshold herein is preset in the user's mind, and whether to contact with the seller is decided by the user.

In addition, in the present embodiment, a communication connection between a user and a product provider may not be established each time after a product image is matched with a user image. After observing the effect of the matched image, the user may determine whether he/she needs to communicate with the product provider. In general, when the user feels unsatisfied after seeing the matched image, the user may not communicate with the product provider. Apparently, a situation may exist that the user feels very satisfied after seeing the matched image, thinks it is unnecessary to communicate with the product provider, and desires to buy the product directly.

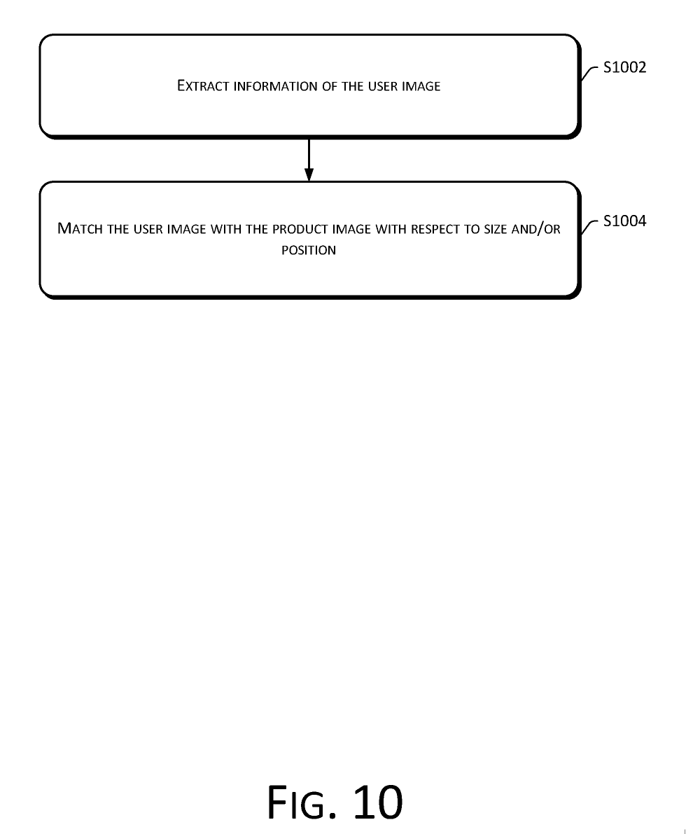

As shown in FIG. 10, in an embodiment, matching and overlaying the product image on the user image may include the following method blocks.

S1002 extracts information of the user image.

S1004 matches the user image with the product image with respect to size and/or position.

In the present embodiment, when matching the product image with the user image, particular parameter(s) of the user image is/are extracted. The particular parameter(s) may include a contour, a shape, a predefined unique image feature, a size, a color, a facial position, etc. A fuzzy matching in size between the user image and the product image may then be performed. The fuzzy matching in size is referred to as a fuzzy matching performed based on product attributes and sizes of the product and the user image. For example, if the product is a dress, when the product image and the user image are matched, the size of the image of the dress overlaid on the user image needs to be about 80% of that of the user image. If the product is a pair of trousers, when the product image and the user image are matched, the size of the image of the trousers overlaid on the user image needs to be about 50% of that of the user image. Matching the user image with the product image in terms of position may also be performed. The position matching is referred to as a matching performed based on product attributes and a rough position of the user image on which the product image to be overlaid. For example, if the product is a T-shirt, the image of the T-shirt needs to be overlaid on the upper part of the user image when the product image and the user image are matched. If the product is a watch, the image of the watch needs to be overlaid on a side position in the middle of the user image when the product image and the user image are matched. In addition, in the present embodiment, the matching between the user image and the product image may be matching with respect to both size and position, or matching with respect to one of the size and the position. Apparently, the matching effect is the best when matching is performed with respect to both the size and the position.

In an embodiment, the interactive communication method may further include fine-tuning the matched image based on an operation of fine-tuning the matched image performed by the user.

In the present embodiment, after observing an effect of the matched image, the user may perform fine-tuning to achieve the best shopping experience according to particular needs. For example, during matching, a dislocation may be inevitable in a matched image as the matching is performed only with respect to either size or position. At this time, the matched image may be finely tuned by the user through a related operation. Apparently, even if the matching is performed with respect to both size and position, it fine-tuning of the matched image may also be performed. No limitation is imposed on the details of a fine-tuning method. For TV shopping, fine-tuning may be performed simply via buttons on a remote control, for example. For shopping via a touchscreen mobile phone, fine-tuning may be performed by touching screen buttons, etc., for example.

In an embodiment, the interactive communication method may further include replacing the product image in the matched image based on an operation of replacing the product image in the matched image performed by the user.

In the present embodiment, after observing the effect of the matched image, the user may change model and color of products of the same type to achieve the best shopping experience. By changing different sizes and colors of the same product only, the position of the user image which the product image is matched with and overlaid on is not changed after the change. For example, the user selects a dress. After observing an effect of matching and overlaying a dress image on his/her image, the user finds that a color of the dress does not suit his/her skin color very well. At that time, he/she may replace the dress image with another image of a dress in a different color through a related operation to achieve the best shopping experience. A precondition of such replacement is that product images used for matching the user image exist in the product information. No limitation is imposed on the details of a manner of replacing a product. For TV Shopping, a replacement of a product may be performed via simple buttons on a remote control, for example. For shopping via a touchscreen mobile phone, a replacement of a product may be performed by touching screen buttons, etc., for instance.

In an embodiment, obtaining the degree of matching between the product image and the user image may include calculating the degree of matching based on features of the product image and the user image, the features including one or more of size, shape or color.

In the present embodiment, a degree of matching may be a level of matching between the product image and the user image with respect to a size, a color, a style, etc. A method of calculating the degree of matching may be set up in the user client terminal in advance. The client terminal may further calculate a value of the degree of matching directly based on specific condition(s) of the matched image using a preset method of calculating the degree of matching. For example, a size and a color may be taken as matching degree parameters. When a level of matching between a product image and a user image with respect to size is within a difference range of 1 cm, a degree of matching between these two images with respect to size is 90%. When the level of matching between the product image and the user image with respect to size is within a difference range of 1-2 cm, the degree of matching between these two images with respect to size is 80%. Similarly, a corresponding degree of matching may also be set up based on a level of matching between two images with respect to color. After the matching between the product image and the user image is finished, the client terminal may calculate a degree of matching every time based on specific condition(s) for matching the two images and a corresponding preset method of calculating a degree of matching. When the user observes the effect of the matched image and cannot determine a degree of satisfaction thereof, to the user may input a reasonable value for the degree of matching through the client terminal. Based on a comparison result between an obtained value for the degree of matching and a preset threshold, the client terminal may also prompt the user that “The product is very suitable. Would you like to contact the seller?”, to improve a success rate of product transaction. In particular, users who are lack of confidence in buying clothes may buy products suitable for themselves in this way.

In an embodiment, the connection may include one or more of a connection for voice communication, a connection for video communication or a connection for text communication.

In the present embodiment, the interactive communication apparatus 100 establishes a communication between the user and the product provider, which may also be triggered by the user as needed. In implementations, establishing a connection for voice communication between a user and a seller may be triggered in response to the user clicking on a “Call the seller” button displayed in an interface, or by collecting information such as a text, a voice, a gesture, a posture, etc., that is indicative of the user's desire to communicate with the seller. For example, when an image capturing component of the client terminal collects a mouth shape or a corresponding gesture, etc., of the user that sounds like “Make a video communication with the seller”, a connection for video communication may be established between the user and the seller.

In addition, in the present embodiment, situations in which a user and a seller conduct a communication through texts, voice and video at the same time may exist. Alternatively, only one or more than one thereof may exist. In general, during TV shopping, a user communicates with a seller mainly through voice or video because inputting a text into a device is not so convenient. No limitation is imposed on the details of a communication method, and a method of communicating with a seller may be selected by a user according to a client terminal used by the user and an environment where the user is located. For example, in an environment such as a public place or a library, a user may prefer to communicate with a seller through a text communication. While at home or in a rather private environment, the user may prefer to communicate with the seller through a voice communication or a video communication, for example.

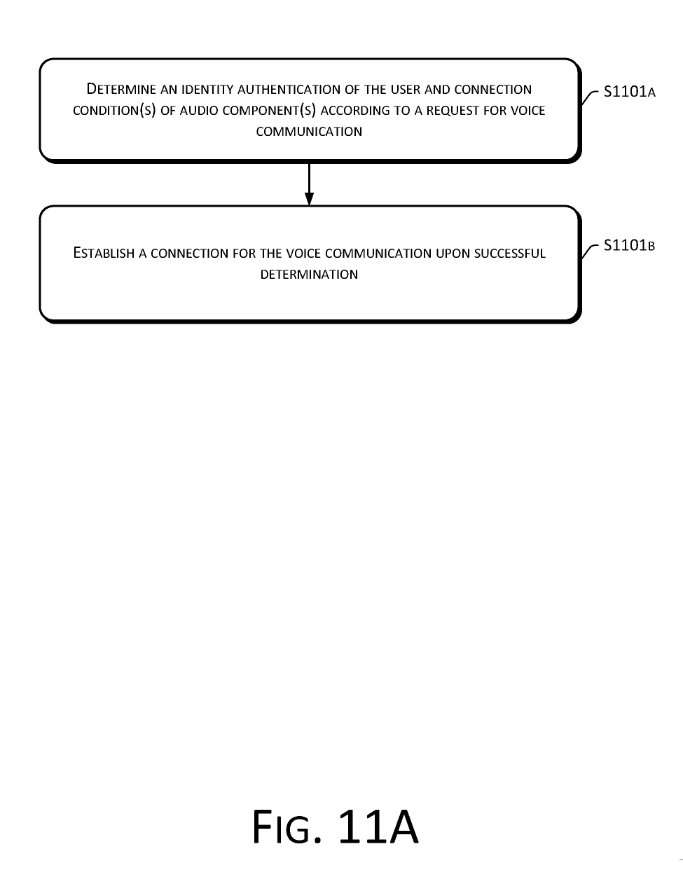

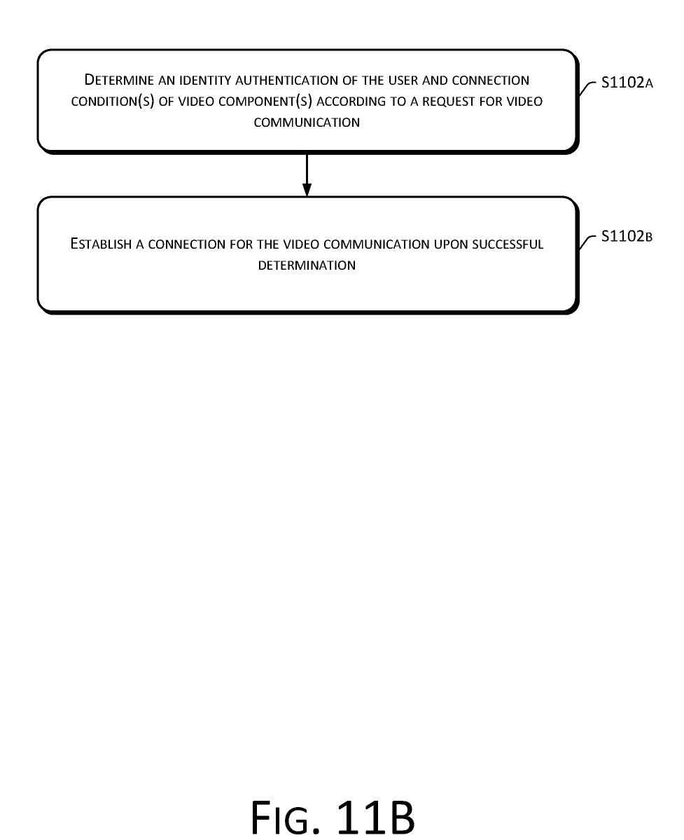

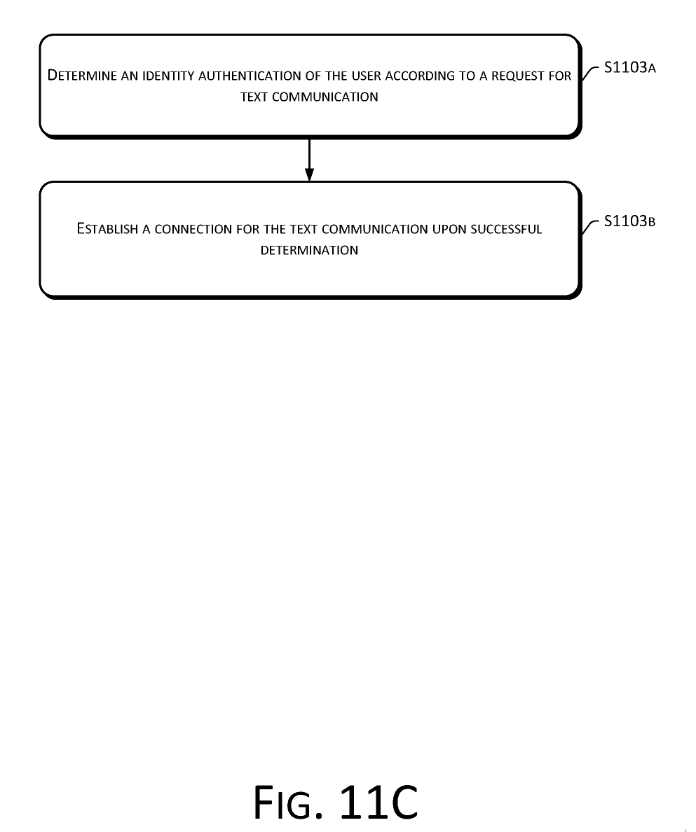

As shown in FIG. 11A, in an embodiment, establishing a connection for voice communication with the product image provider may include the following method blocks.

S1101a determines an identity authentication of the user and connection condition(s) of audio component(s) according to a request for voice communication.

S1101b establishes a connection for the voice communication upon successful determination.

In the present embodiment, during a process of establishing a voice communication between the user and the product seller, authenticating an identity of the user needs to be performed. Under general circumstances, the user is needed to be a member of an associated online shopping platform. In other words, the user has registration information and a login of the user is completed. For example, when shopping in a Taobao/TMALL shopping platform, a Taobao account or an associated account of another platform recognized by the shopping platform needs to be logged in. A determination as to whether a hardware environment for a voice communication is permitted, for example, whether audio receiving/playing device(s) such as a microphone, a loudspeaker, etc., is/are connected, is also needed to be made. A connection for voice communication between the user and the seller is established only after the above determination is successfully completed. No limitation is imposed on the details of implementations of establishing a voice communication, and implementations may be achieved in combination with instant messaging software, for example, Ali Wangwang®, Tencent QQ®, etc.

As shown in FIG. 11B, in an embodiment, establishing a connection for video communication with the product image provider may include the following method blocks.

S1102a determines an identity authentication of the user and connection condition(s) of video component(s) according to a request for video communication.

S1102b establishes a connection for the video communication upon successful determination.

In the present embodiment, during a process of establishing a voice communication between the user and the product seller, an identity of the user needs to be authenticated. Under general circumstances, the user needs to be a member of an associated online shopping platform. In other words, the user has registration information and a login of the user is finished. For example, when shopping in a Taobao/TMALL shopping platform, a Taobao account or an associated account of another platform recognized by the shopping platform needs to be logged in. A determination as to whether a hardware environment for the video communication is permitted, for example, whether video receiving/playing device(s) such as a camera, a microphone, a loudspeaker, etc., is/are connected, is also needed to be performed. A connection for the video communication between the user and the seller is established only after the above determination is successfully completed. No limitation is imposed on the details of implementations of establishing a video communication, and implementations may be achieved in combination with instant messaging software, for example, Ali Wangwang®, Tencent QQ®, Fetion®, etc.

As shown in FIG. 11C, in an embodiment, establishing a connection for text communication with the product image provider may include the following method blocks.

S1103a determines an identity authentication of the user according to a request for text communication.

S1103b establishes a connection for the text communication upon successful determination.

In the present embodiment, during a process of establishing a text communication between the user and the product seller, an authentication of an identity of the user is needed to be performed. Under general circumstances, the user needs to be a member of an associated online shopping platform. In other words, the user has registration information and a login of the user is finished. For example, when shopping in a Taobao/TMALL shopping platform, a Taobao account or an associated account of another platform recognized by the shopping platform needs to be logged in. A determination as to whether a hardware environment for a text communication is permitted, for example, whether text input device(s), such as a voice-to-text conversion device, a keyboard, button(s), is/are connected, is needed to be made. A connection for the text communication between the user and the seller is established only after the above determination is successfully completed. No limitation is imposed on the details of implementations of establishing a text communication, and implementations may be achieved in combination with instant messaging software, for example, Ali Wangwang®, Wechat®, Fetion®, etc.

In an embodiment, after establishing the connection with the product image provider, the method may further include displaying the matched image to the product image provider.

In the present embodiment, after the communication connection is established, the user may choose to permit the matched image to be displayed on a terminal of the product seller, or choose not to permit the matched image to be displayed on the terminal of the product seller. Furthermore, during a process of communication with the user, the product seller may also submit a request for viewing the matched image. After the request is approved by the user, the matched image may also be displayed on the client terminal of the seller. A transmission of the matched image to the client terminal of the seller may be achieved via the established communication connection, to allow a display of the matched image on the client terminal of the seller. Transmission thereof may also be performed through the Internet if both the client terminal of the user and the client terminal of the seller are connected to the Internet, for example. No limitation is imposed on the details of a transmission method.

In an embodiment, the user image may be collected through an image capturing component or retrieved from a storage device.

In the present embodiment, this method block provides the user image for the matching between the user image and the product image. The image capturing component is connected with the client terminal of the user, or directly integrated and deployed in the client terminal of the user, which may be a camera, an image scanner and other devices for collecting image information. In this case, the user image may be obtained and collected through a relevant device. In addition, the user image may also be obtained by directly retrieving an image pre-stored in a storage device. For example, image information stored in the client terminal of the user may be directly selected, and a more suitable image is selected for matching with the product image based on preference(s) of the user and one or more criteria for the matching of the product to be bought. For another example, the user may wish to buy a scarf to match his/her coat. Under a circumstance that the user does not wear the coat or no camera device is present, the user may directly obtain an image thereof when wearing the aforementioned coat from the storage device of the client terminal for matching with the scarf image, and further observe a matching effect, in order to maximize online shopping experience and buy the most suitable product.

In addition, since the user image may be obtained from the storage device, the user may retrieve any image in the client terminal at will to match with the product image, thus enabling the user to buy suitable products for his/her relatives, friends and classmates, and thereby making online shopping to meet people's demands more closely and to be more humanized.

In an embodiment, the product image may be extracted from product information.

In the present embodiment, this method block is mainly employed in a scenario that the product image does not exist alone in the product information. For example, the product image may be placed together with a beautiful packing box of the product or the product is put on/worn by a product model in the product information browsed by the user during online shopping. In this case, prior to matching the user image with the product image, the product image needs to be extracted to allow a matching between the product image and the user image. An example implementation of extracting an image of a product by the first-sixth module 212 may include collecting an image and making portion(s) of the image that do(es) correspond to the product transparent or covering the portion(s) in a colorless manner, etc.

As compared with existing technologies, the disclosed interactive communication method and apparatus perform a matching between a product image and a user image, and obtain a degree of matching between the product image and the user image. When the degree of matching between the product image and the user image meets a preset criterion, a connection between a user and a product provider is established. Specifically, the user is able to determine whether to make a request for establishing a connection with the product provider for further communication after observing an effect of the matching between the product image and the user image. The present disclosure achieves a better effect of product experience for an online shopper to select and purchase a product. Furthermore, an interactive communication between the product provider and the online shopper is enhanced. In particular, after viewing the matched image, the user may perform fine-tuning on the matched image to enhance the matching effect. The user may also select a more suitable product by changing a size and/or a color within a range of products of the same type. In addition, when the user needs to establish a connection with the seller, a communication connection mode such as voice, text and video may be selected, which makes the online shopping of the user to be more humanized.

One skilled in the art should understand that the present disclosure is not limited to the details of the foregoing exemplary embodiments, and the present disclosure can be implemented in other specific forms without departing from the spirit or basic features of the present disclosure. Therefore, the embodiments should be regarded as exemplary and non-limiting from every perspective, and the scope of the present disclosure is defined by the appended claims instead of the above description. Thus, all changes that fall within the meaning and scope of equivalent elements of the claims are intended to be covered by the present disclosure. It is improper to regard any label of the accompanying drawings in a claim as a limitation to the claim that is involved. In addition, the term “include” apparently does not exclude other units or method blocks, and a singular form does not exclude a plural form. Multiple units or apparatuses recited in an apparatus claim may also be implemented by a single unit or apparatus through software or hardware component(s). Terms such as “first”, “second”, etc., are used to represent names, but do not indicate any specific order.

What is claimed is:

1. A method implemented by one or more computing devices, the method comprising:
obtaining a degree of matching between a product image and a user image; and
establishing a connection with a provider of the product image in response to the degree of matching being greater than a preset threshold.

2. The method of claim 1, wherein obtaining the degree of matching comprises:
matching and overlaying the product image on the user image;
displaying a matched image; and
obtaining a degree of matching inputted by a user based at least in part on the matched image.

3. The method of claim 2, wherein matching and overlaying the product image on the user image comprises:
extracting information of the user image; and
matching the user image with the product image with respect to one or more of a size or a position.

4. The method of claim 2, further comprising fine-tuning the matched image based at least in part on an operation of fine-tuning of the matched image performed by the user.

5. The method of claim 2, further comprising replacing the product image in the matched image based at least in part on an operation of replacement of the product image in the matched image performed by the user.

6. The method of claim 1, wherein obtaining the degree of matching comprises:
calculating the degree of matching based at least in part on features of the product image and the user image, the features including one or more of a size, a shape or a color.

7. The method of claim 1, wherein the connection comprises one or more of a connection for a voice communication, a connection for a video communication or a connection for a text communication.

8. The method of claim 1, wherein the connection comprises a connection for a voice communication, and establishing the connection with the provider of the product image comprises:
determining an identity authentication of the user and one or more connection conditions of one or more audio components according to a request for the voice communication; and
establishing the connection for the voice communication upon a successful determination.

9. The method of claim 1, wherein the connection comprises a connection for a video communication, and establishing the connection with the provider of the product image comprises:
determining an identity authentication of the user and one or more connection conditions of one or more video components according to a request for the video communication; and
establishing the connection for the video communication upon a successful determination.

10. The method of claim 1, wherein the connection comprises a connection for a text communication, and establishing the connection with the provider of the product image comprises:
determining an identity authentication of the user according to a request for the text communication; and
establishing the connection for the text communication upon a successful determination.

11. The method of claim 1, wherein after establishing the connection with the provider of the product image, the method further comprises displaying the matched image to the provider of the product image.

12. The method of claim 1, further comprising collecting the user image via an image capturing component or retrieving the user image from a storage device.

13. The method of claim 1, further comprising extracting the product image from product information.

14. One or more computer-readable media storing executable instructions that, when executed by one or more processors, cause the one or more processors to perform acts comprising:
obtaining a degree of matching between a product image and a user image; and
establishing a connection with a provider of the product image in response to the degree of matching being greater than a preset threshold.

15. The one or more computer-readable media of claim 14, wherein obtaining the degree of matching comprises:
matching and overlaying the product image on the user image;
displaying a matched image; and
obtaining a degree of matching inputted by a user based at least in part on the matched image.

16. The one or more computer-readable media of claim 15, wherein matching and overlaying the product image on the user image comprises:
extracting information of the user image; and
matching the user image with the product image with respect to one or more of a size or a position.

17. The one or more computer-readable media of claim 15, the acts further comprising one or more of:
fine-tuning the matched image based at least in part on an operation of fine-tuning of the matched image performed by the user; or
replacing the product image in the matched image based at least in part on an operation of replacement of the product image in the matched image performed by the user.

18. The one or more computer-readable media of claim 14, wherein the connection comprises one or more of a connection for a voice communication, a connection for a video communication or a connection for a text communication.

19. The one or more computer-readable media of claim 14, wherein the connection comprises a connection for a voice communication, and establishing the connection with the provider of the product image comprises:
determining an identity authentication of the user and one or more connection conditions of one or more audio components according to a request for the voice communication; and
establishing the connection for the voice communication upon a successful determination.

20. An apparatus comprising:
one or more processors;
memory;
a first apparatus stored in the memory and executable by the one or more processors to obtain a degree of matching between a product image and a user image; and
a second apparatus stored in the memory and executable by the one or more processors to establish a connection with a provider of the product image in response to the degree of matching being greater than a preset threshold.
